(19) United States
(12) Patent Application Publication
(10) Pub. No.: US 2007/0023350 A1
(43) Pub. Date: Feb. 1, 2007

(54) Apparatus for cutting material within a centrifuge

(76) Inventors: Michael Ray Willert, Nashua, IA (US); Paul E. Van Ausdall, Charles City, IA (US)

Correspondence Address: BANNER & WITCOFF, 1001 G STREET N W, SUITE 1100, WASHINGTON, DC, 20001, US

(21) Appl. No.: 11/191,267

(22) Filed: Jul. 28, 2005

(51) Int. Cl. B04B 3/00

(52) U.S. Cl. 210/376

(57) ABSTRACT

An apparatus for cutting residual cakes within a bottom-unloading centrifuge so that the residual cake can be discharged without putting the operator in jeopardy. The apparatus comprises first and second cutting members that are vertically spaced from each other and an elongated support member secured to the cutting members. The cutting members and the elongated support member are rotatably and vertically moveable within the centrifuge. The apparatus also includes a locking system for securing and maintaining the cutting members in a first, cutting position and a second, rest position.

The present invention relates to an apparatus for cutting material within a bottom-unloader centrifuge basket, more particularly, the present invention relates to a device that cuts the residual cake within the basket of a centrifuge so that the residual cake is safely removed from a surface of the basket without requiring an operator to hand clean the interior of the basket.

### BACKGROUND OF THE INVENTION

Use of a centrifugal separation device allows the extraction of the solid particles from other portions of a mixture. In a centrifugal separator, the separation of the solid from the liquid is commonly accomplished by pumping the contaminated liquid into a high speed rotating chamber or basket. The centrifugal forces created by high speed rotation of the basket cause the contaminated liquid to conform to the interior surface of the rotating basket. The centrifugal energy causes the heavier solids to concentrate in a solid cake form for easy removal, reclamation, reuse or disposal. Since the basket is rotating at a high speed, the solid material adheres to the side of the basket while a cleansed coolant or liquid exits through an opening or openings commonly located at the bottom basket. Centrifugal separation is preferable to the more traditional medium of filtration. However, when centrifugal filtration is performed, a cake begins to form within the basket and the filter screen within the basket becomes clogged, thereby limiting the efficiency of the centrifuge.

Known devices, such as plows, are used to rapidly remove the cake from within the basket. However, plows do not remove the entire cake because the plow cannot come into contact with the filter screen or it will damage the screen. In many centrifuges, as much as two inches of the cake can remain in the basket after the operation of the plow. This remaining portion of the cake that is packed against the filter screen is known as the residual cake or heel. In most instances, the residual cake has to be removed because it slows down the filtration, because the user wishes to recover the entire product or because the user wishes not to mix multiple batches or products. To remove the residual cake, it may require that the operator manually introduce a member, such as a hand trowel, into the basket while the basket is spinning. This exposes the operator to physical danger and may result in the operator being seriously injured. Alternatively, the removal of the residual cake requires the shutting down and opening the centrifuge. It either instance, an operator may come into contact with toxic, flammable or other dangerous products. What is more, the product may deteriorate when it comes into contact with the open air.

### BRIEF SUMMARY OF THE INVENTION

An aspect of the present invention includes an apparatus for cutting residual cake within a centrifuge so that the residual cake can be discharged without putting the operator in jeopardy. The apparatus comprises first and second cutting members that are vertically spaced from each other and an elongated support member secured to the cutting members. The cutting members and the elongated support member are rotatably and vertically moveable within the centrifuge. The apparatus also includes a locking system for securing and maintaining the cutting members in a first, cutting position and a second, rest position.

A manual system or powered drive system can be used to vertically and rotationally move the elongated shaft and cutting members toward and away from the lower inner surface of the basket. After the cutting members move from a first rest position to a second, lower rest position, the elongated shaft and cutting members are rotated into a residual cake cutting position. When the cutting members are rotated into the first, cutting position, the cutting members are located immediately adjacent to the wall surface of the filter, yet not in physical contact with the wall surface. At this position, the cutting members can contact and create up to a two inch score in a residual cake within the basket of the centrifuge.

Each cutting member includes a blade having a cutting surface that faces the cutting surface of the opposing blade. These opposing cutting surfaces cause the cut portions of the residual cake to be directed away from the lower and upper surfaces of the basket, thereby preventing the cut portions from being wedged between the cutting blades and portions of the basket. The cut portions of the residual cake are discharged from the basket through the main solids discharge opening.

### BRIEF DESCRIPTION OF THE DRAWINGS

FIG. 1 is a schematic view of a portion of a centrifuge including a material cutting apparatus according to an aspect of the present invention with cutting members being shown in both rest and cutting positions;

FIG. 2 is a partial broken away schematic view of a portion of the centrifuge of FIG. 1 with the cutting members in a rest position;

FIG. 3 is a schematic top view of the portion of the centrifuge of FIG. 1 with the cutting members shown in a lower rest position and a lower engaged position;

FIG. 4 is a cross section of a support shaft shown in FIG. 1;

FIGS. 5 and 6 illustrate portions of a locking mechanism shown in FIG. 1;

FIG. 7 illustrates a housing for the locking mechanism shown in FIG. 1;

FIGS. 8A and 8B illustrate a lower cutting member of FIG. 1;

FIGS. 9A-9C illustrate an upper cutting member of FIG. 1;

FIGS. 10 and 11 illustrate an indexing plate of a rotational positioning system shown in FIG. 1;

FIG. 12 illustrates a stopping plate of a rotational positioning system shown in FIG. 1;

FIG. 13 illustrates a spacing washer that cooperates with the stopping plate of FIG. 12;

FIGS. 14 and 15 illustrate a retainer plate of a rotational positioning system shown in FIG. 1; and

FIG. 16 illustrates a handle for turning the shaft and cutting members shown in FIG. 1.

### DETAILED DESCRIPTION OF THE INVENTION

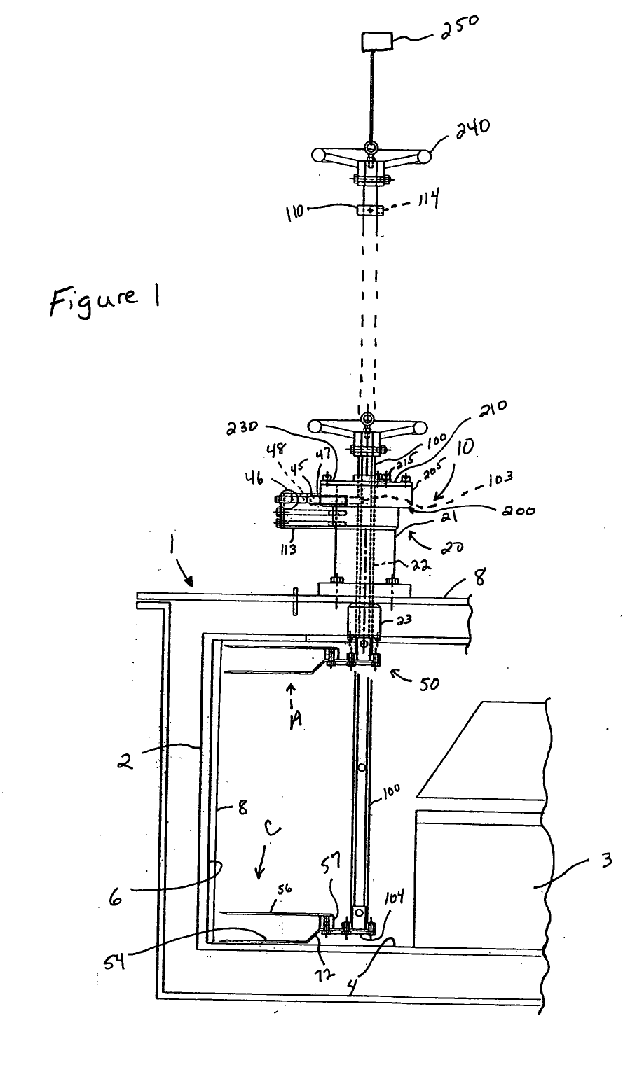

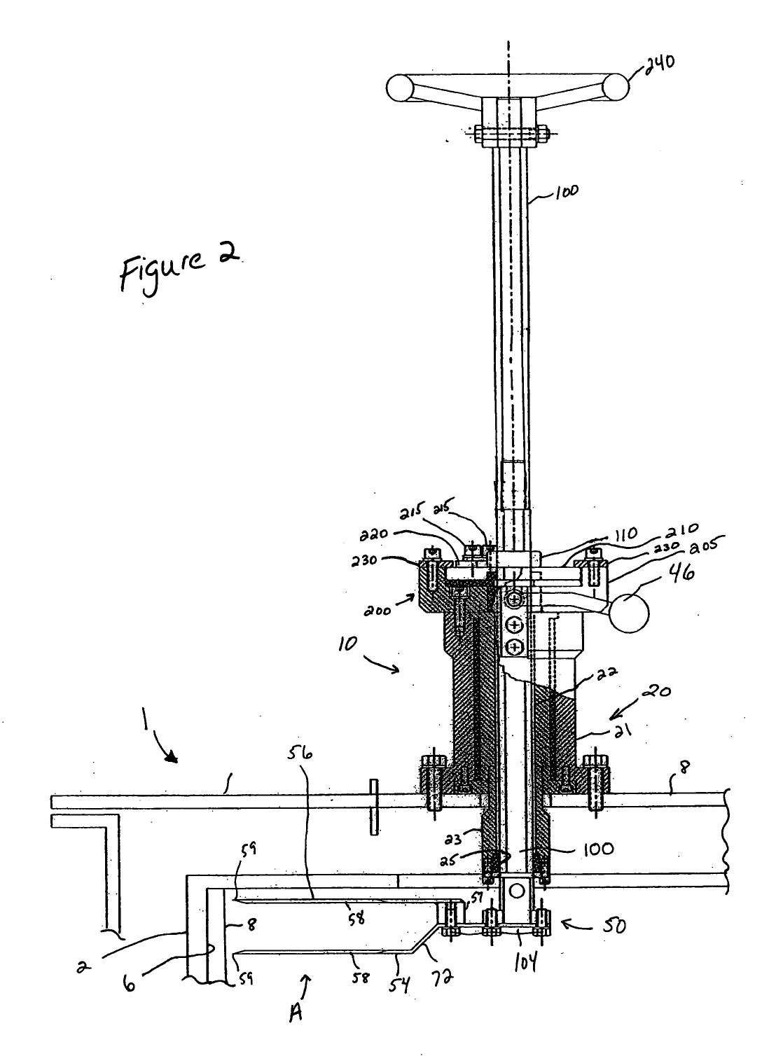

FIGS. 1 and 2 illustrate a portion of a basket 2 of a top loading, bottom discharge centrifuge 1 as known in the art. An example of such a centrifuge 1 is a TOLHURST centrifuge. As understood in the art, the basket 2 can be connected to a drive shaft and motor (riot shown) and rotated about a vertically disposed axis that extends through the centrifuge 1. The basket 2 comprises an inner bottom surface 4 and a vertically extending sidewall 6. The basket 2 also includes a wire-mesh cloth or screen 8 that extends along the length of the vertical sidewall 6. As appreciated by those skilled in the art, the basket 2 may include, as necessary, the appropriate bearings and seals that support the basket 2 as it rotates at a high rate and separates the subject material located within the basket 2, while maintaining an isolated environment within the basket 2.

As shown in FIGS. 1 and 2, the centrifuge 1 also includes a material removal apparatus 10 for cutting (scoring) a residual cake 3 that remains within the basket 2 of the centrifuge 1 after operation of the centrifuge 1. The apparatus 10 comprises a positioning assembly 20 that provides both vertical and rotational positioning to cutting members 54, 56 of a cutting assembly 50. The positioning assembly sets the cutting members 54, 56 at desired heights and locations within the basket 2 so the residual cake 3 can be cut (scored) by cutting members 54, 56 and removed from within the basket 2 through the bottom discharge opening (not shown).

The positioning assembly 20 is secured to the cover 8 of the centrifuge 1 as shown in FIGS. 1 and 2. The positioning assembly 20 comprises a housing 21 that includes an internal passage 22 sized and shaped to receive a centrally positioned support shaft 100. The positioning assembly 20 also includes a spacing member 23 having an internal bearing surface and guide collar 25 that spaces the cutting members 54, 56 a predetermined distance below the inside surface of the cover 8 and within the basket 2.

As illustrated in FIGS. 1 and 2, the support shaft 100 extends vertically through at least a portion of the basket 2 and the cover 8. The shaft 100 is moveable toward and away from the bottom surface 4 of the basket 2 along an axis that extends through the cover 8. In the illustrated embodiment, the shaft 100 has a total length of between about 37 and 41 inches. In an embodiment, the shaft 100 has a length of about 39.4 inches. The shaft 100 also has a width of between about 1.15 and 1.35 inches. In an embodiment, the width is about 1.27 inches. However, the length and width of the shaft 100 may change with the size of the centrifuge 1.

As shown in FIG. 4, the support shaft 100 has a substantially octagonal cross section with four substantially planar sides 102 connected by angled sections 101. In the illustrated embodiment, each planar side 102 has a length of about 1.25 inches. This shape provides the support shaft 100 with additional strength to resist torsion and other forms of deformation while cutting of the residual cake occurs. The support shaft 100 is formed of a known material. One such material includes DELRON plastic. Other known materials that resist torsion could also be used.

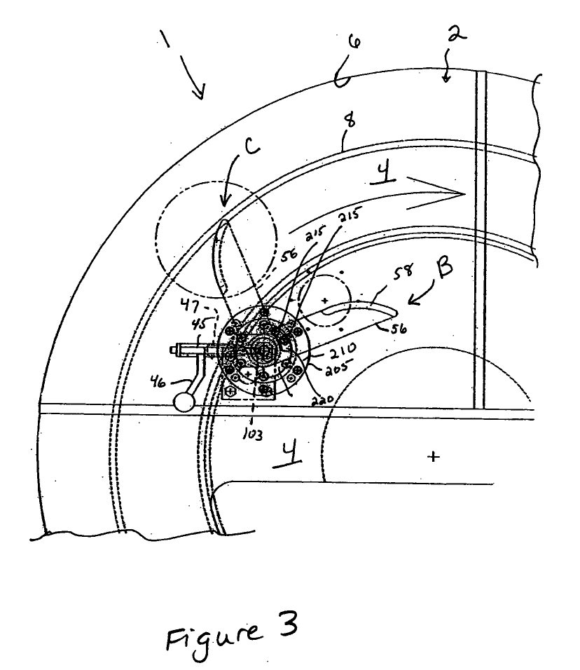

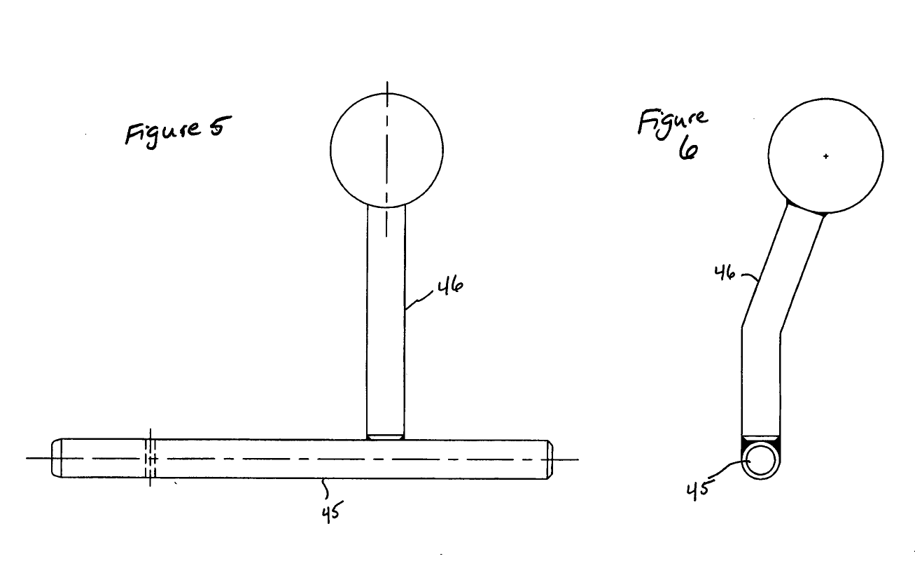

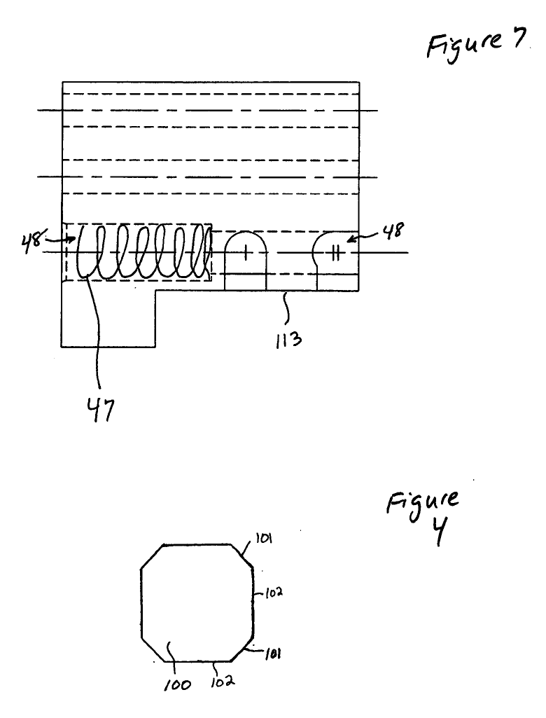

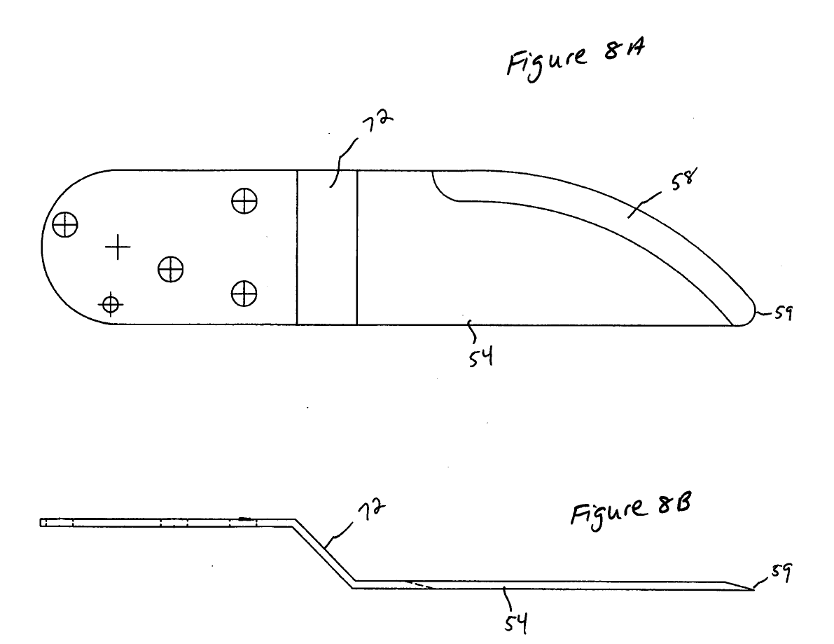

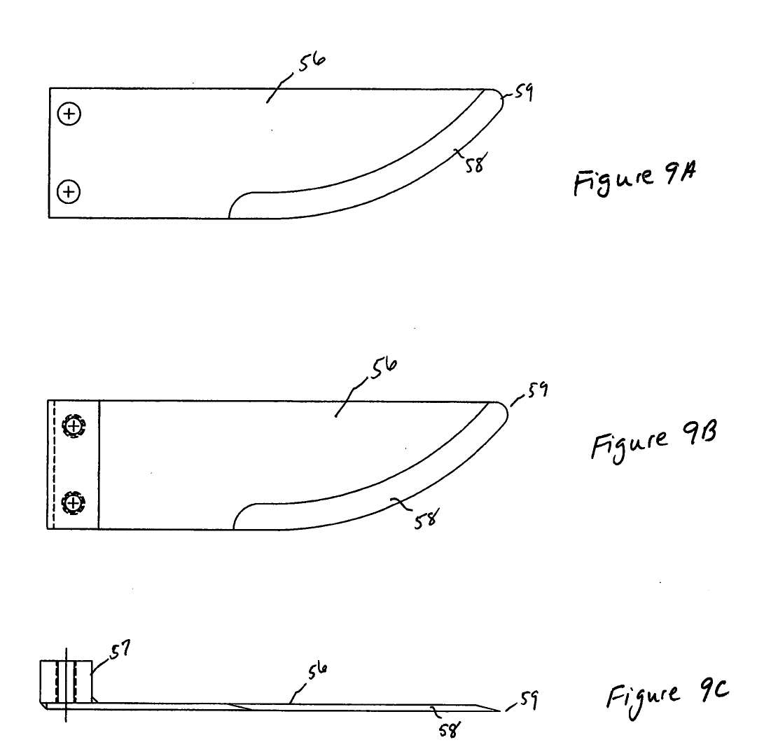

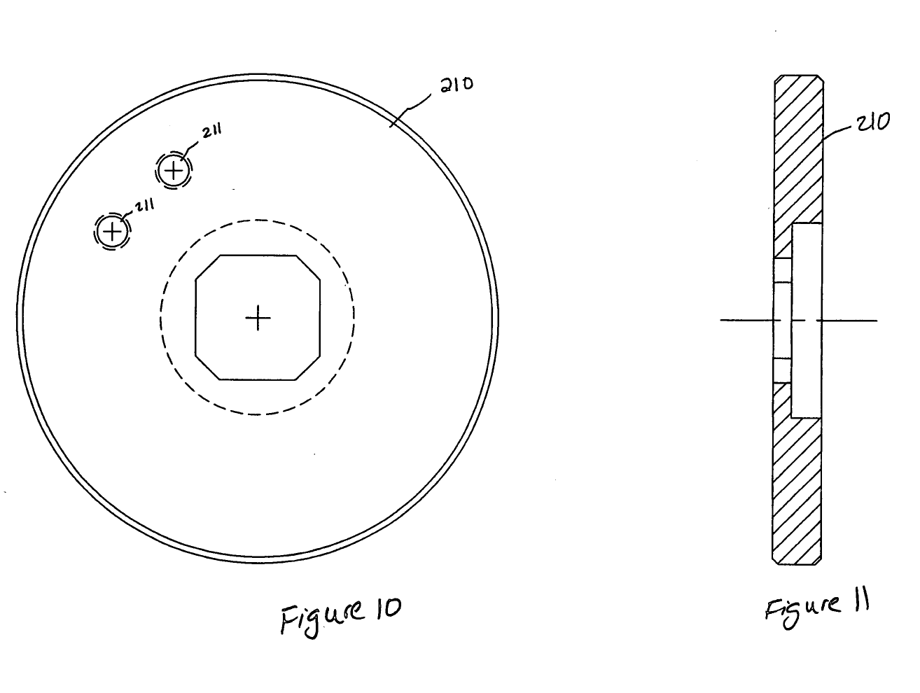

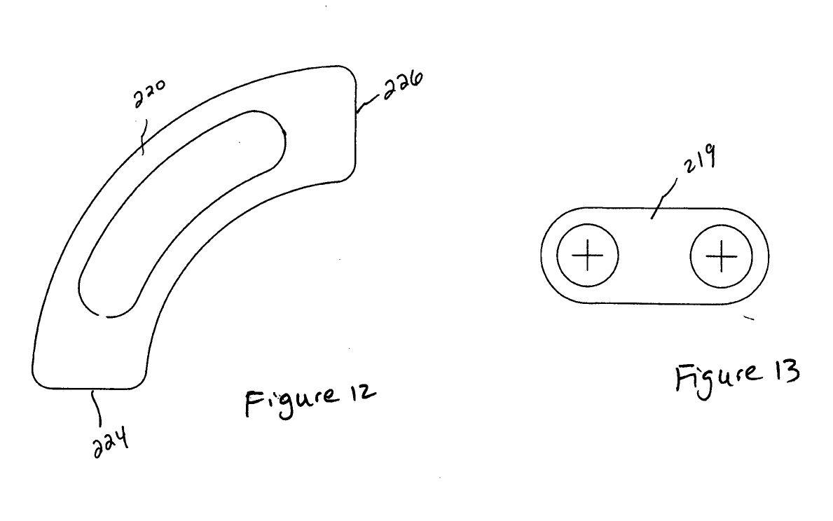

The shaft 100 is held in either a raised or lowered vertical position by a release system 44, illustrated in FIGS. 1, 3 and 5. The release system 44 comprises a sliding, cylindrical member 45 that is received within an opening 103 in the support shaft 100. A handle 46 that can be grasped by an operator extends from the sliding member 45. A spring 47 or other known resilient member biases the cylindrical member 45 in the direction of the support shaft 100. During use, the operator pulls on the handle 46 to retract the cylindrical member away from the shaft 100 and against the force of the spring 47. In response to the operator pulling on the handle 46, the cylindrical member 45 moves within a channel 48 (FIG. 7) extending through a support housing 113 that is secured to, and extends from, the housing 21. When this occurs, the support shaft 100 is separated from the cylindrical member 45 and free to move vertically and rotationally relative to the basket 2.

The shaft 100 carries a stopping member 110 for limiting the length of its vertical travel within the basket 2. FIGS. 1 and 2 illustrate a stop collar 110 that is moveable along the length of the support shaft 100. The collar 110 can be secured to the support shaft 100 at any point along its length in order to set the height of the lower end 104 of the shaft 100 and the cutting members 54, 56 above the bottom surface 4 of the basket 2. The collar 110 can be secured using a well known manner including a friction fit between a bolt 114 advanced through a portion of the collar 110 and into engagement with the support shaft 100. Alternatively, the stop collar 110 can be secured to the support shaft 100 using a detent and sliding member. As the shaft 100 is advanced into the basket 2 and the cutting members 54, 56 moved toward the bottom surface 4, the collar 110 will contact an upper surface of an indexing plate 210. When this occurs, the vertical movement of the shaft 100 and the cutting members 54, 56 stops and the cutting height of the cutting members 54, 56 above the bottom surface 4 is set.

As shown in FIGS. 1 and 2, the cutting assembly 50 comprises a pair of vertically spaced cutting members 54, 56 secured proximate the lower end 104 of support shaft 100. The cutting members 54, 56 can be formed of any known cutting tools including knife blades 57 having cutting edges 58. However, other known cutting members could also be used to cut the residual cake within the centrifuge 1. The cutting edge 58 of each blade 57 is shaped to follow the contour of the screen 8 and effectively cut the residual cake 3. In the illustrated embodiment, the cutting edge 58 has a radius of curvature of about 6 inches. The terminal end 59 of the cutting edge 58 is slightly rounded. The terminal end 59 has a radius of curvature of about 0.25 inch.

As shown in FIG. 1, the cutting edge 58 of the lower cutting member 54 is angled away from the bottom surface 4 of the basket 2 in order to prevent a cut portion of the residual cake from being thrown and wedge between the lower cutting member 54 and the bottom surface 4. Similarly, the cutting edge 58 of the upper cutting member 56 faces away from the cover 8 so that cut portions of the residual cake 3 are not thrown between the cutting member 56 and an upper surface of the basket 2.

The cutting members 54, 56 can vary in length depending on the size of the basket in the centrifuge 1. In the illustrated embodiment, the cutting members 54, 56 extend between about eight inches and nine inches from the shaft 100 and score a two inch slit in the residual cake. The cutting members 54, 56 are vertically spaced from each other in a direction parallel to the length of the shaft 100. The upper cutting member 56 is vertically spaced between about 0.75 inch and 1.0 inch above the lower cutting member 54. The distance between the two cutting members 54, 56 is maintained by a spacer nut 57. The cutting members 54, 56 can be secured to the spacer nut 57 by bolts, screws, welds, adhesives or other known securing techniques. The cutting members 54, 56 could be spaced by a greater or lesser distance depending on the size of the basket 2 and the residual cake within the basket 2. While the cutting members 54, 56 are shown to be vertically aligned, in an alternative embodiment the cutting members 54, 56 can be rotationally offset from each other (not shown).

The lower cutting member 54 includes an angled section 72 that operatively secures the lower cutting member 54 to the lower end 104 of the support shaft 100. The offset positioning of the cutting edge 58 relative to the lower end 104, created by the angled section 72, locates the cutting edge 58 closer to the bottom of the basket 2 than the lower end 104 of the support shaft 100. An angled bracket could be used in place of angled section 72 to secure the lower cutting member 54 to the support shaft 100. The offset created by the angled section 72 positions the lower cutting member 54. The offset also spaces the bottom surface of the lower cutting member 54 from the bottom of the basket 2 by a distance of about 0.25 inch or less when the collar 110 is in contact with the indexing plate 210. Alternatively, the distance between the lower cutting member 54 and the bottom of the basket 2 could be greater than 0.25 inch.

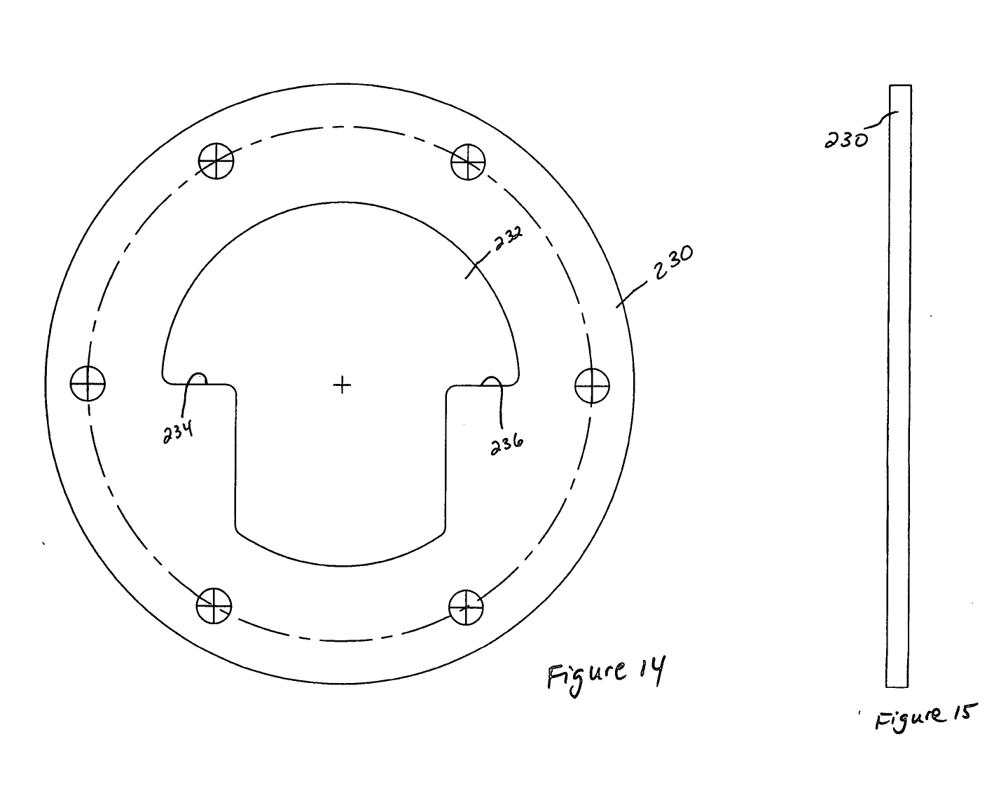

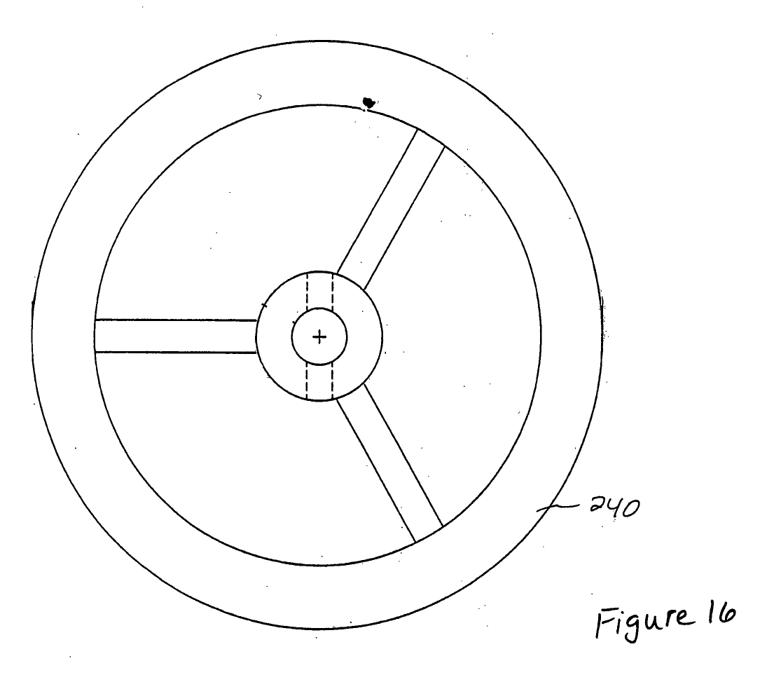

The positioning apparatus 20 also includes a rotational positioning system 200 secured to the housing 21 for limiting the rotational movement of the support shaft 110 and the secured cutting members 54, 56 within the basket 2. The rotational positioning system 200 limits how far the cutting members 54, 56 can rotate within the basket 2 in response to the rotation of their support shaft 100. The rotational positioning system 200 includes the indexing plate 210 positioned within a recess in a positioning system housing 205. The indexing plate 210 includes at least two recesses 211 that receive elongated members 215, such as threaded bolts. The threaded members 215 also extend through washer 219 (FIG. 13) that extends above a stopping plate 220. As shown in FIG. 12, the stopping plate 220 is substantially arcuate in shape. The stopping plate 220 is positioned within an open region 232 of a retainer plate 230. The open region 232 has a substantially hemispherical shape as illustrated in FIG. 14. The open region 232 also includes two stopping surfaces 234, 236 that contact the stopping plate 220 to stop the rotation of the shaft 100 and the arcuate travel of the cutting members 54, 56 as discussed below.

The stopping plate 220 is allowed to travel between about 82 and 92 degrees within the open region 232. This, in turn, limits the arcuate travel of the cutting members 54, 56 to between 82 and 92 degrees. In a preferred embodiment, the arcuate travel of the stop plate 220 and cutting members 54, 56 would be between about 84 and 88 degrees. In one embodiment, the arcuate travel is about 85 degrees. Greater or lesser amounts of arcuate travel of the stop plate 220, and thus the support shaft 100 and cutting members 54, 56, can be provided to compensate for wear of the cutting edges 58, materials being cut or the like.

During the operation of the centrifuge 1, the cutting members 54, 56 are maintained in the upper rest position A. In upper rest position A, the cutting members 54, 56 are vertically spaced above the residual cake and adjacent to the cover of the basket 2, as shown in FIG. 2. In the rest position A, the cutting members 54, 56 are positioned out of engagement with the cake and other portions of the centrifuge 1. This allows for normal operation of the centrifuge 1. The cutting members 54, 56 are held in rest position A by the cylindrical member 45 being engaged with the support shaft 100. As the handle 46 is pulled backwards, away from the support shaft 100, the cylindrical member 45 slides out of engagement with the support shaft 100. An operator can then advance the support shaft 100 into the basket 2, thereby simultaneously lowering the cutting members 54 in the direction of the bottom surface 4 of the basket 2. When the collar 110 engages the indexing plate 210, the vertical movement of the cutting members 54, 56 stops and the cutting members 54, 56 assume a lower rest position B. In this position B, the cutting members 54, 56 achieve their intended cutting height, but they have not been rotated into engagement with the residual cake. As illustrated, when in the partially engaged position B, the first cutting member 54 will be substantially adjacent the bottom surface 4. In such an embodiment, the lower surface of the lower cutting member 54 can be positioned about 0.25 inch from the bottom surface 4. The cutting members 54, 56 can also be incrementally lowered so that the residual cake can be cut at incremental heights, thereby allowing the residual cake to be cut away in stages. The support shaft 100 can include indicia to identify the depth of the cutting members 54, 56 within the basket 2.

After the cutting height of the cutting members 54, 56 is achieved, the support shaft 100 is rotated and the cutting members 54, 56 are moved from the lower rest position B to the engaged position C. The support shaft 100 is rotated by an operator turning a drive wheel 240 or a motor and drive arrangement attached to the support shaft 100 (not shown). The drive wheel 240 or motor and drive arrangement can also be used to raise and lower the support shaft 100 and cutting members 54, 56. A counter weight 250 can be secured to the drive wheel 240 to secure the centrifuge 1.

In the illustrated embodiment, the rotation of the wheel 240 causes the support shaft 100 to engage and rotate the indexing plate 210, which carries the stopping plate 220. When the forward edge 224 of the stopping plate 220 engages the stop surface 234, the rotation of the indexing plate 210, the shaft 100 and the cutting members 54, 56 toward the screen 8 is stopped because the cutting members 54, 56 have assumed the cutting position C, shown in FIG. 1. In the cutting position C, a terminal end of each cutting member 54, 56 is positioned immediately adjacent to the inner surface of the screen 8. As shown, the cutting members 54, 56 are not in physical contact with the wall of the screen 8, thus the screen 8 is free of contact and damage from the cutting members 54, 56.

After the residual cake has been cut sufficiently for removal, the support shaft 100 is rotated in the opposite direction and the cutting members 54, 56 move away from the screen 8 toward the lower rest position B. When a rearward edge 226 of the stopping plate 220 engages the stopping surface 236, the stopping surface 236 prevents any additional movement of the shaft 100 and indexing plate 210 in the direction away from the screen 8 because the cutting members 54, 56 have returned to the lower rest position B. The cylindrical member 45 is again backed away from the support shaft 100 by the operator pulling on the handle 46. The shaft 100 may then be raised to return the cutting members 54, 56 to the upper rest position A. The handle 46 is then released and the spring 47 forces the cylindrical member 45 back into secure engagement with the support shaft 100.

Numerous characteristics, advantages and embodiments of the invention have been described in detail in the foregoing description with reference to the accompanying drawings. However, the disclosure is illustrative only and the invention is not limited to the illustrated embodiments. Various changes and modifications may be effected therein by one skilled in the art without departing from the scope or spirit of the invention.

What is claimed:

1. An apparatus for cutting material within a centrifuge, said apparatus comprising first and second cutting members vertically spaced from each other, an elongated support member secured to said cutting members, said elongated support member and cutting members being rotatably and vertically moveable within the centrifuge, and a lock for maintaining the cutting members in a first, cutting position and a second, rest position.

2. The apparatus according to claim 1 further comprising a rotational positioning system that limits the rotation of said cutting members and said elongated support member.

3. The apparatus according to claim 2 wherein said rotational positioning system comprises a first plate, a second plate including an open area and a third plate positioned within said open area and secured to said first plate.

4. The apparatus according to claim 3 wherein said open area of said second plate includes stop surfaces that limit the rotational travel of said third plate within said open area.

5. The apparatus according to claim 4 wherein said open area has a semi-circular shape, and said third plate travels approximately 90 degrees or less within said open area between the stop surfaces.

6. The apparatus according to claim 1 wherein said elongated support member comprises a shaft having a substantially octagonal cross section.

7. The apparatus according to claim 1 further comprising a member secured to said elongated member for moving said cutting members from a rest position to a cutting position.

8. The apparatus according to claim 7, wherein said cutting position is arcuately spaced between about 82 and 92 degrees from said rest position.

9. The apparatus according to claim 1 wherein said elongated support member comprises a shaft having a lower surface, and wherein at least one of said cutting members is secured to said shaft such that it is offset and vertically spaced below said lower surface.

10. The apparatus according to claim 1 further comprising a locking mechanism for holding the elongated support member and cutting members in at least one predetermined position.

11. The apparatus according to claim 10 wherein the locking mechanism comprises a spring biased member that is moveably positioned within a housing for engaging the elongated member and maintaining said elongated member at a predetermined position.

12. The apparatus according to claim 1 wherein the cutting members include opposed cutting blades that are vertically disposed above each other.

13. The apparatus according to claim 12 wherein each cutting blade has an angled cutting surface that faces the cutting surface of the other, opposed cutting blade.

14. The apparatus according to claim 3 wherein said elongated support member includes a stop adjustably positioned along its length, and wherein said stop limits vertical movement of said elongated support member in at least one direction when said stop contacts a surface of said first plate.

15. A centrifuge comprising a basket having a lower inner surface, a screen and a system for cutting a residual cake within said basket as said basket rotates, said system for cutting the residual cake comprising an elongated support member and cutting members secured to said elongated member, said cutting members being moveable vertically and rotationally within said basket from a rest position where they are free from contacting the residual cake to an operating position where at least one of said cutting members is positioned for contacting the residual cake.

16. The centrifuge according to claim 15 wherein each said cutting member comprises a cutting blade having at least one cutting edge for contacting the residual cake while the basket is rotating.

17. The centrifuge according to claim 15 wherein a first of said cutting members is vertically positioned below a second of said cutting members.

18. The centrifuge according to claim 17 wherein the first cutting member is spaced from the lower inner surface of the basket by a distance of about 0.25 inch when in said operating position.

19. The centrifuge according to claim 18 wherein the first cutting member is positioned closer to said lower inner surface of said basket relative to a lower end surface of said elongated support member.

20. The centrifuge according to claim 17 wherein said first cutting member is offset from a lower surface of said elongated support member such that said first cutting member is proximate the lower inner surface of said basket when said elongated support member is in said operating position.

21. The centrifuge according to claim 15 further comprising a rotational positioning system that limits the rotation of said cutting members and said elongated support member.

22. The centrifuge according to claim 21 wherein said rotational positioning system comprises a first plate, a second plate including an open area and a third plate positioned within said open area and secured to said first plate.

23. The centrifuge according to claim 22 wherein said open area of said second plate includes stop surfaces that limit the movement of said third plate within said open area.

24. The centrifuge according to claim 23 wherein said open area has a semi-circular shape, and said third plate travels 90 degrees or less within said open area.

25. The centrifuge according to claim 15 wherein said elongated support member comprises a shaft having a substantially octagonal cross section.

26. The centrifuge according to claim 15 further comprising a locking mechanism for holding the elongated support member and cutting members in first and second vertical positions within said basket.

27. The centrifuge according to claim 26 wherein the first vertical position is spaced further from the bottom surface of said basket than said second vertical position.

28. The centrifuge according to claim 26 wherein the locking mechanism comprises a spring biased member that is moveably positioned within a housing for engaging the elongated support member and maintaining said elongated support member at said first and second vertical positions.
